(19) United States
(12) Patent Application Publication
(10) Pub. No.: US 2020/0055982 A1
(43) Pub. Date: Feb. 20, 2020

(54) Process for Producing a Polyester Polyol, the Polyester Polyol Produced Thereby, and Use of the Polyester Polyol

(71) Applicant: Far Eastern New Century Corporation, Taipei City (TW)

(72) Inventors: Yu-Chun Wu, Taipei City (TW); Chun-Chieh Chien, Taipei City (TW); Chih-Yuan Tseng, Taipei City (TW)

(21) Appl. No.: 16/416,672

(22) Filed: May 20, 2019

(30) Foreign Application Priority Data
Aug. 16, 2018 (TW) 107128647

(51) Int. Cl. C08G 63/78; C08G 63/672; C08G 18/42; C08J 9/12

(52) U.S. Cl. CPC C08G 63/78; C08G 63/672; C08J 2375/06; C08J 9/125; C08G 18/4258

(57) ABSTRACT

A process for producing a polyester polyol includes the steps of: (a) preparing a diol composition which includes a C₂-C₉ short-chain diol component and a diol monomeric component of Formula (I) defined herein in a weight ratio of the C₂-C₉ short-chain diol component to the diol monomeric component of Formula (I) of larger than 0 and less than 1.6, (b) preparing a dicarbonyl composition which includes one selected from the group consisting of a dicarboxylic acid component, a dicarboxylic anhydride component, and a combination thereof, and (c) subjecting the diol composition and the dicarbonyl composition to a polycondensation reaction.

### CROSS-REFERENCE TO RELATED APPLICATION

This application claims priority to Taiwanese Patent Application No. 107128647 filed Aug. 16, 2018, the disclosure of which is hereby incorporated by reference in its entirety.

### FIELD

The disclosure relates to a process for producing a polyester polyol, and more particularly to a process for producing a polyester polyol having flame retardancy.

### BACKGROUND

In order to produce a flame-retardant foam, a flame-retardant additive is usually added during production of the foam.

Taiwanese Invention Patent No. 1425081 discloses a method of forming a flame-retardant foam, which comprises mixing a polyol, a layered inorganic powdery material, a phosphorous-containing flame retardant, and a nitrogen-containing flame retardant to obtain a mixture, then adding an isocyanate to the mixture followed by foaming to form the flame-retardant foam. The phosphorous-containing flame retardant and the nitrogen-containing flame retardant are added so as to permit the thus formed foam to have flame retardancy.

U.S. Patent Publication No. 2015/0051304 discloses an aromatic polyester polyol which is suitable to be used as the sole polyol in the production of a polyurethane foam without addition of any polyether polyols. However, addition of flame retardant is needed so as to permit the thus produced polyurethane foam to have flame retardancy.

The flame-retardant effect of the polyurethane foam is significantly affected by the dispersion degree of the flame retardant in polyester polyol, which is a component for the production of the polyurethane foam. Therefore, in the prior art, the flame-retardant effect of the flame-retardant foam may be undesirably affected if the dispersion degree of the flame retardant in the polyester polyol is inferior. In order to enhance the dispersion degree of the flame retardant in the polyester polyol, the flame retardant may be subjected to surface modification and/or may be dispersed in polyester polyol using a specific dispersant, which may result in an increase in production cost. Furthermore, when it is intended to permit the flame-retardant foam to have additional functions such as yellow-resistance, antibacterial and antistatic properties, the dispersion degree of the flame retardant in the polyester polyol may be further reduced when supplementary additives having the additional functions are added, which may decrease the flame-retardant effect of the polyurethane foam produced thereby.

### SUMMARY

Therefore, a first object of the disclosure is to provide a process for producing a polyester polyol having intrinsic flame retardancy without addition of flame retardant.

A second object of the disclosure is to provide a polyester polyol having intrinsic flame retardancy.

A third object of the disclosure is to provide a polyurethane foam having flame retardancy.

According to a first aspect of the disclosure, there is provided a process for producing a polyester polyol, comprising the steps of:

(a) preparing a diol composition which includes a C₂-C₉ short-chain diol component and a diol monomeric component of Formula (I) in a weight ratio of the C₂-C₉ short-chain diol component to the diol monomeric component of Formula (I) of larger than 0 and less than 1.6,

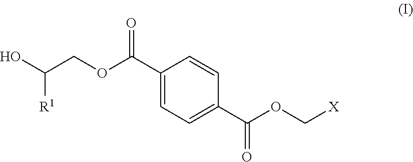

wherein

R¹ is selected from the group consisting of hydrogen, phenyl, a C₁-C₆ straight alkyl group, and a C₃-C₆ branched alkyl group, and

X is selected from the group consisting of

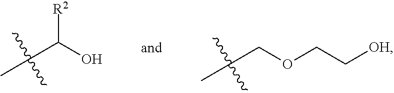

wherein R² is selected from the group consisting of hydrogen, phenyl, a C₁-C₆ straight alkyl group, and a C₃-C₆ branched alkyl group;

(b) preparing a dicarbonyl composition which includes one selected from the group consisting of a dicarboxylic acid component, a dicarboxylic anhydride component, and a combination thereof; and

(c) subjecting the diol composition and the dicarbonyl composition to a polycondensation reaction.

According to a second aspect of the disclosure, there is provided a polyester polyol produced by the process according to disclosure.

According to a third aspect of the disclosure, there is provided a polyurethane foam produced by subjecting the polyester polyol according to the disclosure and a polyisocyanate to a reaction.

In the process for producing a polyester polyol according to the disclosure, the diol monomeric component of Formula (I) is used in admixture with the C₂-C₉ short-chain diol component in a specific weight ratio to prepare the diol composition. The thus produced polyester polyol has a superior crystallinity and is provided with superior flame retardancy accordingly. Therefore, a polyurethane foam having superior flame retardancy can be produced using the polyester polyol produced by the method according to the disclosure, without further addition of flame retardant.

In addition, the thus produced polyester polyol has superior dispersibility due to use of the diol monomeric component of Formula (I) in admixture with the C₂-C₉ short-chain diol component in a specific weight ratio to prepare the diol composition for producing the polyester polyol. Therefore, the additives desirable to be added into the polyester polyol to permit the polyurethane foam produced thereby to have additional functions can be well-dispersed in the polyester polyol.

### DETAILED DESCRIPTION

A process for producing a polyester polyol according to the disclosure comprises the steps of:

(a) preparing a diol composition which includes a C₂-C₉ short-chain diol component and a diol monomeric component of Formula (I) in a weight ratio of the C₂-C₉ short-chain diol component to the diol monomeric component of Formula (I) of larger than 0 and less than 1.6,

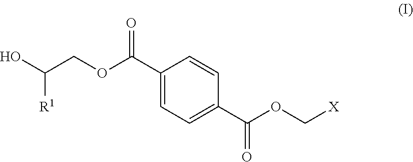

wherein

R¹ is selected from the group consisting of hydrogen, phenyl, a C₁-C₆ straight alkyl group, and a C₃-C₆ branched alkyl group, and

X is selected from the group consisting of

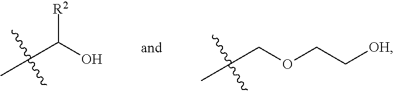

wherein R² is selected from the group consisting of hydrogen, phenyl, a C₁-C₆ straight alkyl group, and a C₃-C₆ branched alkyl group;

(b) preparing a dicarbonyl composition which includes one selected from the group consisting of a dicarboxylic acid component, a dicarboxylic anhydride component, and a combination thereof; and

(c) subjecting the diol composition and the dicarbonyl composition to a polycondensation reaction.

### Diol Composition:

The diol composition includes a C₂-C₉ short-chain diol component and a diol monomeric component of Formula (I) in a weight ratio of the C₂-C₉ short-chain diol component to the diol monomeric component of Formula (I) of larger than 0 and less than 1.6,

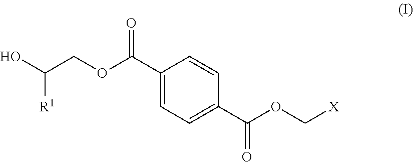

wherein

R¹ is selected from the group consisting of hydrogen, phenyl, a C₁-C₆ straight alkyl group, and a C₃-C₆ branched alkyl group, and

X is selected from the group consisting of

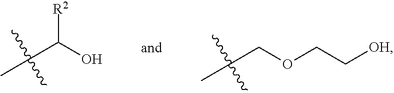

wherein R² is selected from the group consisting of hydrogen, phenyl, a C₁-C₆ straight alkyl group, and a C₃-C₆ branched alkyl group.

In certain embodiments, the diol monomeric component of Formula (I) includes a first diol monomer of Formula (I-1)

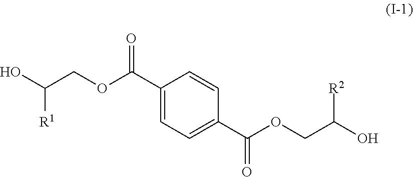

(i.e., the diol monomeric component of Formula (I) wherein X is

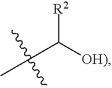

wherein each of R¹ and R² is independently selected from the group consisting of hydrogen, phenyl, a C₁-C₆ straight alkyl group, and a C₃-C₆ branched alkyl group.

In certain embodiments, both R¹ and R² in Formula (I-1) is hydrogen.

Since the first diol monomer of Formula (I-1) has a symmetrical structure, the polyester polyol produced thereby can have a superior crystallinity so as to permit the polyester polyol to have superior flame retardancy. A non-limiting example of the first diol monomer of Formula (I-1) is bis(2-hydroxyethyl terephthalate.

In certain embodiments, the diol monomeric component of Formula (I) includes a second diol monomer of Formula (I-2)

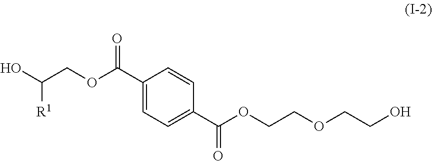

(i.e., the diol monomeric component of Formula (I) wherein X is

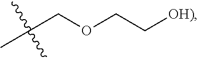

wherein R¹ is selected from the group consisting of hydrogen, phenyl, a C₁-C₆ straight alkyl group, and a C₃-C₆ branched alkyl group.

In certain embodiments, R¹ in Formula (I-2) is hydrogen.

Since the second diol monomer of Formula (I-2) has a symmetrical structure, the polyester polyol produced thereby can have a superior crystallinity so as to permit the polyester polyol to have superior flame retardancy. Additionally, the second diol monomer of Formula (I-2) has surfactant characteristics (i.e., having both hydrophilicity and lipophilicity) and the molecular chain thereof is sufficiently long to produce steric hindrance. Therefore, the second diol monomer of Formula (I-2) has superior dispersibility, and the polyester polyol produced thereby can have superior dispersibility accordingly. A non-limiting example of the second diol monomer of Formula (I-2) is 2-(2-hydroxyethoxy)ethyl 2-hydroxyethyl terephthalate. In certain embodiments, the diol monomeric component of Formula (I) includes a combination of the first diol monomer of Formula (I-1) and the second diol monomer of Formula (I-2). As described above, the first diol monomer of Formula (I-1) has superior flame retardancy and the second diol monomer of Formula (I-2) has both superior flame retardancy and superior dispersibility. Therefore, the polyester polyol produced using a combination of the first diol monomer of Formula (I-1) and the second diol monomer of Formula (I-2) can have further enhanced flame retardancy and superior dispersibility.

In the embodiments in which a combination of the first diol monomer of Formula (I-1) and the second diol monomer of Formula (I-2) is used in the diol composition, when the amount of the second diol monomer of Formula (I-2) is too low, the polyester polyol produced thereby may have unsatisfactory dispersibility. When the amount of the second diol monomer of Formula (I-2) is too high, the molecular chain of the second diol monomer of Formula (I-2) is liable to entangle, which may undesirably affect the dispersibility of the polyester polyol produced thereby. Therefore, in the embodiments in which a combination of the first diol monomer of Formula (I-1) and the second diol monomer of Formula (I-2) is used in the diol composition, a weight ratio of the first diol monomer of Formula (I-1) to the second diol monomer of Formula (I-2) is in a range from 6:1 to 11:1. In certain embodiments, the weight ratio of the first diol monomer of Formula (I-1) to the second diol monomer of Formula (I-2) is in a range from 7:1 to 10:1.

When a combination of the first diol monomer of Formula (I-1) and the second diol monomer of Formula (I-2) is used in the diol composition in step (a) of the process for producing a polyester polyol according to the disclosure, in order to prevent the first diol monomer of Formula (I-1) from self-polymerization, the second diol monomer of Formula (I-2) from self-polymerization, and the first diol monomer of Formula (I-1) and the second diol monomer of Formula (I-2) from polymerization with each other, the first diol monomer of Formula (I-1) and the second diol monomer of Formula (I-2) are mixed with each other at a mixing temperature which is lower than a prepolymerization temperature at which the first diol monomer of Formula (I-1) and the second diol monomer of Formula (I-2) are subjected to a prepolymerization reaction.

In certain embodiments, the mixing temperature is in a range from 120° C. to 180° C.

The C₂-C₉ short-chain diol component included in the diol composition used in step (a) has a carbon number up to 9 in view of the fact that the polyester polyol produced thereby can have superior dimensional stability. In certain embodiments, the C₂-C₉ short-chain diol component is selected from the group consisting of ethylene glycol, diethylene glycol, propylene glycol, butanediol, and combinations thereof. In certain embodiments, the C₂-C₉ short-chain diol component is diethylene glycol.

In addition to implement the polycondensation reaction with the dicarbonyl composition, the C₂-C₉ short-chain diol component is also used as a diluent to regulate viscosity of the polyester polyol produced thereby so as to permit the polyester polyol to have proper viscosity. As such, the polyester polyol can be homogeneously mixed with polyisocyanate and various optional functional additives to produce polyurethane foam having desirable superior performances.

In addition, when the amount of the C₂-C₉ short-chain diol component included in the diol composition is too high, the amount of diol monomeric component of Formula (I) is reduced accordingly, leading to undesirable decrease of the flame retardancy of the polyester polyol produced thereby. When the amount of the C₂-C₉ short-chain diol component included in the diol composition is too low, the viscosity of the polyester polyol produced thereby is relatively high, which may be unfavorable for the production of the polyurethane foam. Therefore, in certain embodiments, the weight ratio of the C₂-C₉ short-chain diol component to the diol monomeric component of Formula (I) in the diol composition used in step (a) is larger than 0 and less than 1.6 so as to permit the polyurethane foam produced thereby to have superior flame retardancy. In certain embodiments, the weight ratio of the C₂-C₉ short-chain diol component to the diol monomeric component of Formula (I) in the diol composition used in step (a) is in a range from 0.8 to 1.4 so as to permit the polyurethane foam produced thereby to have both superior flame retardancy and superior foamability. In certain embodiments, the weight ratio of the C₂-C₉ short-chain diol component to the diol monomeric component of Formula (I) in the diol composition used in step (a) is in a range from 1.1 to 1.4.

### Dicarbonyl Composition:

The dicarbonyl composition includes one selected from the group consisting of a dicarboxylic acid component, a dicarboxylic anhydride component, and a combination thereof.

Examples of the dicarboxylic acid component include, but are limited to, phthalic acid, maleic acid, fumaric acid, succinic acid, and combinations thereof.

Examples of the dicarboxylic anhydride component include, but are not limited to, maleic anhydride, phthalic anhydride, succinic anhydride, and combinations thereof.

In certain embodiments, a molar ratio of the dicarbonyl composition to the diol composition is in a range from 0.2:1 to 0.6:1. In certain embodiments, the molar ratio of the dicarbonyl composition to the diol composition is in a range from 0.3:1 to 0.6:1.

### Polycondensation Reaction:

In certain embodiments, the polycondensation reaction in step (c) is implemented at a temperature ranging from 180° C. to 300° C. In certain embodiments, the polycondensation reaction in step (c) is implemented at a temperature ranging from 180° C. to 250° C. In certain embodiments, the polycondensation reaction in step (c) is implemented at a temperature ranging from 180° C. to 220° C.

In certain embodiments, the polycondensation reaction in step (c) is implemented in the presence of a catalyst so as to enhance the polycondensation reaction. Examples of the catalyst include, but are not limited to, tributyl tin, ethylene glycol antimony, antimony acetate, antimony trioxide, and combinations thereof. The examples of the catalyst may be used alone or in admixture of two or more thereof.

### Polyester Polyol:

Polyester polyol produced by the process according to the disclosure has an alcohol value in a range of from 200 mg KOH/g to 700 mg KOH/g. When the alcohol value of the polyester polyol is less than 200 mg KOH/g, the polyester polyol may have a relatively high viscosity such that it is difficult to mix the polyester polyol with polyisocyanate homogeneously so as to produce a polyurethane foam. When the alcohol value of the polyester polyol is larger than 700 mg KOH/g, the polyurethane foam produced thereby is relatively brittle and has a relatively low compressive strength (i.e., inferior deformation resistance). Therefore, in certain embodiments, the alcohol value of the polyester polyol is in a range from 300 mg KOH/g to 400 mg KOH/g.

When the polyester polyol produced thereby has proper viscosity, the polyester polyol can be homogeneously mixed with polyisocyanate and various optional functional additives during the production of the polyurethane foam. Therefore, in certain embodiments, the polyester polyol has a viscosity in a range of 3,000 cP to 60,000 cP at 25° C.

As described above, since the thus produced polyester polyol is provided with superior flame retardancy, the polyurethane foam produced thereby has superior flame retardancy.

Furthermore, the thus produced polyester polyol is in a form of liquid with good fluidity and dispersibility such that it can be mixed with polyisocyanate and various optional functional additives homogeneously to produce the polyurethane foam.

In addition, the thus produced polyester polyol does not have problems such as discoloration (for example, yellowing), which is a commonly occurred phenomenon. Therefore, polyurethane foam produced thereby can be easily colored to enhance the appearance thereof.

### Polyurethane Foam:

The polyurethane foam can be produced by subjecting the thus produced polyester polyol and a polyisocyanate to a reaction.

Various additives can be optionally used for the production of polyurethane foam. Examples of the additives include, but are not limited to, foaming agents, catalysts, pigments, and the like. The types and the amounts of the additives are not specifically limited and can be selected and adjusted according to specific requirements for the polyurethane foam to be produced.

Examples of the polyisocyanate include, but are not limited to, aliphatic polyisocyanate, aromatic polyisocyanate, and a combination thereof. Examples of the aliphatic polyisocyanate include, but are not limited to, 1,6-hexamethylene diisocyanate (HDI), isophorone diisocyanate (IPDI), dicyclohexylmethane-4,4′-diisocyanate (HMDI), and cyclohexane diisocyanate (CHDI). The examples of the aliphatic polyisocyanate may be used alone or in admixture of two or more thereof. Examples of the aromatic polyisocyanate include, but are not limited to, methylenediphenyl diisocyanate (MDI) and toluene diisocyanate (TDI). The examples of the aromatic polyisocyanate may be used alone or in admixture of two or more thereof.

In the production of the polyurethane foam, a weight ratio of the polyisocyanate to the polyester polyol is not specifically limited, and may be in a range from 1:1 to 3:1. It should be noted that when the weight ratio of the polyisocyanate to the polyester polyol is larger than 3:1 (for example, 4:1 or 5:1), the polyurethane foam produced thereby is relatively brittle.

The polyurethane foam thus produced can be used as polyisocyanurate foam (PIR) and specifically as rigid polyurethane foam (PUR).

Examples of the disclosure will be described hereinafter. It is to be understood that these examples are exemplary and explanatory and should not be construed as a limitation to the disclosure.

### Example 1

Bis(2-hydroxyethyl terephthalate (referred to as BHET hereinafter, 36 kg, 141.7 mol) and 2-(2-hydroxyethoxy)ethyl 2-hydroxyethyl terephthalate (referred to as BHEET hereinafter, 4 kg, 13.4 mol) were added into a reactor. A weight ratio of BHET to BHEET was 9:1, and a total weight of BHET and BHEET was 40 kg. The reactor was heated to 120° C. BHET and BHEET in the reactor were stirred at 50 rpm. The reactor was vacuumed until pressure therein reached 120 torr. The reactor was then heated at 120° C. for 30 minutes.

Diethylene glycol (referred to as DEG hereinafter, 56 kg, 528.3 mol) and phthalic anhydride (referred to as PA hereinafter, 34 kg, 229.7 mol) were then added into the reactor. The reactor was heated from 120° C. to 200° C., and maintained at 200° C. for 30 minutes. Tributyl tin (referred to as TBT hereinafter, 0.04 kg, purchased from Echo Chemical Co., Ltd.) was then added into the reactor.

Nitrogen gas was fed into the reactor from a bottom thereof at a flow rate of 1 L/min, followed by reaction for 4 hours. Sampling was taken every half an hour, and acid value of each sample was measured. When the acid value was more than 5 mg KOH/g, the reaction was continued with heating under stirring. When the acid value was less than 5 mg KOH/g, the heating under stirring was stopped to terminate the reaction. Nitrogen gas was fed into the reactor from a top thereof until the pressure in the reactor reached 1 kg. The reactor was then closed, and was cooled to a temperature ranging from 50° C. to 70° C. Polyester polyol thus produced was discharged from the bottom of the reactor.

### Example 2

Example 2 was implemented according to the procedure of Example 1 except that 90 g (0.354 mol) of BHET, 10 g (0.034 mol) of BHEET, 140 g (1.321 mol) of DEG, 85 g (0.574 mol) of PA, and 0.1 g of TBT were used in this example. The weight ratio of BHET to BHEET was 9:1 and the total weight of BHET and BHEET was 100 g (0.388 mol) in this example.

### Example 3

Example 3 was implemented according to the procedure of Example 2 except that 120 g (1.132 mol) of DEG was used in this example.

### Example 4

Example 4 was implemented according to the procedure of Example 2 except that 100 g (0.943 mol) of DEG was used in this example.

### Examples 5

Example 5 was implemented according to the procedure of Example 2 except that 80 g (0.755 mol) of DEG was used in this example.

### Example 6

Example 6 was implemented according to the procedure of Example 2 except that ethylene glycol (referred to as EG hereinafter, 140 g, 2.25 mol) was used in place of DEG used in Example 2.

### Examples 7

Example 7 was implemented according to the procedure of Example 2 except that EG (130 g, 2.096 mol) was used in place of DEG used in Example 2.

### Example 8

Example 8 was implemented according to the procedure of Example 2 except that EG (120 g, 1.935 mol) was used in place of DEG used in Example 2.

### Examples 9

Example 9 was implemented according to the procedure of Example 2 except that EG (110 g, 1.774 mol) was used in place of DEG used in Example 2.

### Example 10

Example 10 was implemented according to the procedure of Example 2 except that 91.66 g (0.36 mol) of BHET and 8.34 g (0.028 mol) of BHEET were used in this example. The weight ratio of BHET to BHEET was 11:1 and the total weight of BHET and BHEET was 100 g (0.388 mol) in this example.

### Example 11

Example 11 was implemented according to the procedure of Example 2 except that 90.9 g (0.358 mol) of BHET and 9.1 g (0.03 mol) of BHEET were used in this example. The weight ratio of BHET to BHEET was 10:1 and the total weight of BHET and BHEET was 100 g (0.388 mol) in this example.

### Example 12

Example 12 was implemented according to the procedure of Example 2 except that 88.89 g (0.35 mol) of BHET and 11.11 g (0.037 mol) of BHEET were used in this example. The weight ratio of BHET to BHEET was 8:1 and the total weight of BHET and BHEET was 100 g (0.387 mol) in this example.

### Example 13

Example 13 was implemented according to the procedure of Example 2 except that 87.5 g (0.344 mol) of BHET and 12.5 g (0.042 mol) of BHEET were used in this example. The weight ratio of BHET to BHEET was 7:1 and the total weight of BHET and BHEET was 100 g (0.386 mol) in this example.

### Example 14

Example 14 was implemented according to the procedure of Example 2 except that 85.72 g (0.337 mol) of BHET and 14.28 g (0.048 mol) of BHEET were used in this example. The weight ratio of BHET to BHEET was 6:1 and the total weight of BHET and BHEET was 100 g (0.385 mol) in this example.

### Comparative Example 1

Polyethylene terephthalate (referred to as PET hereinafter, 100 g, 5×10⁻³ mol, average molecular weight of 2×10⁴, commercially available from Far Eastern New Century Corp. under the designation CB-608) was added into a reactor. The reactor was heated to 220° C. to melt PET. Molten PET in the reactor was then stirred at 50 rpm. The reactor was vacuumed until the pressure therein reached 120 torr. The reactor was then heated at 220° C. for 30 minutes.

DEG (140 g, 1.321 mol) and PA (85 g, 0.574 mol) were then added into the reactor. The reactor was maintained at 220° C. for 30 minutes followed by addition of TBT (0.1 g) into the reactor.

Nitrogen gas was fed into the reactor from a bottom thereof at a flow rate of 1 L/min, followed by reaction for 4 hours. Sampling was taken every half an hour, and acid value of each sample was measured. When the acid value was more than 5 mg KOH/g, the reaction was continued with heating under stirring. When the acid value was less than 5 mg KOH/g, the heating under stirring was stopped to terminate the reaction. Nitrogen gas was fed into the reactor from a top thereof until the pressure in the reactor reached 1 kg. The reactor was then closed, and was cooled to a temperature ranging from 50° C. to 70° C. Polyester polyol thus produced was discharged from the bottom of the reactor.

### Comparative Example 2

Terephthalic acid (referred to as TPA hereinafter, 65 g, 0.39 mol) was added into a reactor. The reactor was heated to 220° C. TPA in the reactor was then stirred at 50 rpm. The reactor was vacuumed until the pressure therein reached 120 torr. The reactor was then heated at 220° C. for 30 minutes.

DEG (140 g, 1.321 mol) and PA (85 g, 0.574 mol) were then added into the reactor. The reactor was maintained at 220° C. for 30 minutes followed by addition of TBT (0.1 g) into the reactor.

Nitrogen gas was fed into the reactor from a bottom thereof at a flow rate of 1 L/min, followed by reaction for 4 hours. Sampling was taken every half an hour, and acid value of each sample was measured. When the acid value was less than 5 mg KOH/g, the reaction was continued with heating under stirring. When the acid value was less than 5 mg KOH/g, the heating under stirring was stopped to terminate the reaction. Nitrogen gas was fed into the reactor from a top thereof until the pressure in the reactor reached 1 kg. The reactor was then closed, and was cooled to a temperature ranging from 50° C. to 70° C. Polyester polyol thus produced was discharged from the bottom of the reactor.

### Comparative Example 3

Commercially available STEPANPOL® PS-2502A polyester polyol was used as this comparative example, which had an alcohol value of 240±5 mg KOH/g and a viscosity of 3000 cP at 25° C.

### Comparative Example 4

Comparative Example 4 was implemented according to the procedure of Example 2 except that 180 g (1.698 mol) of DEG was used in this comparative example.

### Comparative Example 5

Comparative Example 5 was implemented according to the procedure of Example 2 except that 160 g (1.509 mol) of DEG was used in this comparative example.

### Application Example: Production of Polyurethane Foam

Polyester polyol (19.4 g) of each of the aforesaid examples and comparative examples, a foaming agent (0.2 g, L-6900 from Momentive Performance Material Inc.), a catalyst (0.2 g, DABCO® 33LV), and pure water (0.2 g) were added into a stirrer, followed by stirring at 2000 rpm for 1 minute to obtain a composition. Diphenylmethane diisocyanate (18.03 g, PMDI 807B from Harry Materials Association), except for the polyester polyol of Comparative Example 3) was added into the composition in the stirrer, followed by stirring at 2000 rpm for 30 seconds to obtain a mixture. The mixture was poured into a mold having a dimension of 10 cm×10 cm×1 cm, followed by foaming for 5 minutes to obtain a polyurethane foam.

When the polyester polyol of Comparative Example 3 was used for production of the polyurethane foam, diphenylmethane diisocyanate was used in an amount of 12.02 g.

### Property Evaluation:

### 1. Viscosity of Polyester Polyol:

The viscosity of polyester polyol at 25° C. was measured using a viscometer (Model: Brookfield DV-111 ULTRA Rheometer).

### 2. Alcohol Value of Polyester Polyol:

### (i) Preparation of a Titrant Solution:

100 ml of a 1 M aqueous tetrabutylammonium hydroxide (Bu₄NOH, TBAH) solution was diluted to a volume of 1 L with isopropanol to prepare a 0.1 N TBAH titrant solution.

### (ii) Measurement of Alcohol Value:

Polyester polyol was formulated into a sample solution according to ASTM E 1899. The sample solution was titrated with the 0.1 N TBAH titrant solution using an autotritrator (Manufacturer: Metrohm AG; Model: 888 Titrando). The consumed volumes (V₁, V₂) of the 0.1 N TBAH titrant solution at the first and second endpoints of the titration were recorded. The alcohol value of the polyester polyol was calculated according to the formula below:

Alcohol Value(mg KOH/g)=[(V₂−V₁)×N×56.1]/W

wherein
V₁: Consumed volume (in ml) of the 0.1 N TBAH titrant solution at the first endpoint of the titration;
V₂: Consumed volume (in ml) of the 0.1 N TBAH titrant solution at the second endpoint of the titration;
N: Normality of the 0.1 N TBAH titrant solution; and
W: Weight (in g) of polyester polyol.

### 3. Melt Drop:

Polyurethane foam (10 cm×10 cm×1 cm) was burned using a flame gun (Manufacturer: Eastway; Model: T-9026, flame temperature: 1100° C.) for 1 minute and the burning condition was observed to determine whether melt drop was produced during the period.

### 4. Surface Resistance:

0.2 g, 0.4 g, 0.6 g, and 0.8 g of aqueous carbon nanotube suspensions were respectively used in place of 0.2 g of pure water in the production of polyurethane foam to produce anti-static polyurethane foams. The aqueous carbon nanotube suspension (referred to as CNT suspension) was TUBALL™ INK H₂O 0.2% from Evermore Trade Corp. and contained 0.2 wt % of single-walled carbon nanotubes.

The surface resistance of each of the thus produced anti-static polyurethane foams (dimension: 10 cm×10 cm×1 cm) was measured using a surface resistance meter (FRASER 740SRM) according to ASTM D257.

### 5. Foamability:

Foaming procedure of polyurethane foam was observed during the production thereof.

### 6. Three-Point Compression Value (N/cm²):

The compression value of each polyurethane foam sample (10 cm×5 cm×1 cm) was measured using a Sero Tensile Strength Tester from Perfect International Instruments Co., Ltd. according to ASTM C 293. The higher the compression value, the better the structural strength and the deformation resistance of the polyurethane foam sample.

### Property Evaluation Results:

The property evaluation results of Example 2 and Comparative Examples 1 to 3 are shown in Tables 1 and 2 below.

TABLE 1

| | | Comparative | Comparative | Comparative |
|---|---|---|---|---|
| | Example 2 | Example 1 | Example 2 | Example 3 |
| Polyester | BHET + BHEET + | PET + DEG + PA | TPA + DEG + PA | STEPANPOL ® |
| Polyol | DEG + PA | | | PS-2502A |
| | BHET:BHEET = 9: | PET = 100 g | TPA = 65 g | |
| | 1 | DEG = 140 g | DEG = 140 g | |
| | BHET + BHEET = | PA = 85 g | PA = 85 g | |
| | 100 g | | | |
| | DEG = 140 g | | | |
| | PA = 85 g | | | |
| Viscosity at | 10,000 | 35,000 | 32,000 | 3,000 |
| 25° C. | | | | |
| (cP) | | | | |
| Alcohol value | 360 ± 5 | 350 ± 5 | 360 ± 5 | 240 ± 5 |
| (mg KOH/g) | | | | |
| Melt drop | ◯* | X** | X | X |

Note:
*“◯”: polyurethane foam did not have melt drop phenomena
**“X”: polyurethane foam had melt drop phenomena and was not flame-retardant

TABLE 2

| | | Surface | |
|---|---|---|---|
| | | resistance | Melt |
| Polyurethane foam | | (Ω/m²) | drop |
| Ex. 2 | 0.2 g pure | >10¹² | ◯* |
| BHET + BHEET + DEG + PA | water | | |
| BHET:BHEET = 9:1 | 0.2 g CNT | >10¹² | ◯ |
| | suspension | | |
| | 0.4 g CNT | 10¹¹ | ◯ |
| | suspension | | |
| | 0.6 g CNT | 10¹⁰ | ◯ |
| | suspension | | |
| | 0.8 g CNT | 10⁹ | ◯ |
| | suspension | | |
| Comp. Ex. 1 | 0.2 g pure | >10¹² | X** |
| PET + DEG + PA | water | | |
| | 0.2 g CNT | >10¹² | X |
| | suspension | | |
| | 0.4 g CNT | >10¹² | X |
| | suspension | | |
| | 0.6 g CNT | >10¹² | X |
| | suspension | | |
| | 0.8 g CNT | 10¹¹ | X |
| | suspension | | |
| Comp. Ex. 3 | 0.2 g pure | >10¹² | X |
| STEPANPOL ® PS-2502A | water | | |
| | 0.2 g CNT | >10¹² | X |
| | suspension | | |
| | 0.4 g CNT | >10¹² | X |
| | suspension | | |
| | 0.6 g CNT | >10¹² | X |
| | suspension | | |
| | 0.8 g CNT | 10¹¹ | X |
| | suspension | | |

Note:
*“◯”: no melt drop phenomena
**“X”: melt drop phenomena

As shown in Table 1, the polyurethane foam produced using the polyester polyol of Example 2 does not have melt drop production, demonstrating that the polyester polyol of Example 2 produced using the diol monomeric component of Formula (I) has superior flame retardancy. Contrary thereto, the polyurethane foams produced using the polyester polyols of Comparative Examples 1 to 3 have melt drop production, indicating that the polyester polyols of Comparative Examples 1 to 3 do not have flame retardancy.

Comparing to the polyester polyols of Comparative Examples 1 and 2, the polyester polyol of Example 2 produced using the diol monomeric component of Formula (I) has a relatively low viscosity, and thus can be mixed with polyisocyanate and various optional additives easily to produce the polyurethane foam.

As shown in Table 2, the polyurethane foam produced using the polyester polyol of Example 2 has a surface resistance which is significantly reduced when the amount of the aqueous carbon nanotube suspension used for the production thereof is gradually increased. It is demonstrated that the polyester polyol of Example 2 produced using the diol monomeric component of Formula (I) has superior dispersibility such that the aqueous carbon nanotubes suspension can be dispersed in the polyester polyol sufficiently so as to produce the polyurethane foam having a significantly reduced surface resistance. Contrary thereto, each of the polyurethane foams produced using the polyester polyols of Comparative Examples 1 and 3 has a surface resistance which is not significantly reduced when the amount of the aqueous carbon nanotube suspension used for the production thereof is gradually increased. Specifically, when the amount of the aqueous carbon nanotube suspension was in a range from 0.4 g to 0.8 g, each of the polyurethane foams produced using the polyester polyols of Comparative Examples 1 and 3 has a surface resistance which is relatively high compared to that of the polyurethane foam produced using the polyester polyol of Example 2 and using the same amount of the aqueous carbon nanotube suspension. It is indicated that each of the polyester polyols of Comparative Examples 1 and 3 has inferior dispersibility such that the aqueous carbon nanotube suspension cannot be sufficiently dispersed in the polyester polyol to produce the polyurethane foam having a significantly reduced surface resistance. In addition, the polyurethane foam produced using the polyester polyol of Example 2 together with 0.4 g of the aqueous carbon nanotube suspension has a surface resistance which is substantially the same as those of the polyurethane foams produced using the polyester polyols of Comparative Examples 1 and 3 together with 0.8 g of the aqueous carbon nanotube suspension. Therefore, the production cost for the polyurethane foam produced using the polyester polyol of Example 2 can be significantly reduced compared to those of the polyurethane foam having the same surface resistance produced using the polyester polyols of Comparative Examples 1 and 3, due to reduction of the amount of the aqueous carbon nanotube suspension.

The results shown in Tables 1 and 2 demonstrate that the polyester polyol produced using the diol monomeric component of Formula (I) has superior flame retardancy and dispersibility. Therefore, the polyurethane foam having superior flame retardancy can be produced favorably. In addition, various additives can be optionally added to permit the polyurethane foam to have additional functions without compromising the flame retardancy of the polyurethane foam.

The property evaluation results of the polyurethane foams produced using the polyester polyols of Examples 10 to 14, in which the diol monomeric component of Formula (I) was used and in which the amount of DEG was 140 g and the amount of PA was 85 g, are shown in Table 3 below.

TABLE 3

| | | Surface | |
|---|---|---|---|
| | | resistance | Melt |
| Polyurethane foam | | (Ω/m²) | drop |
| Example 10 | 0.2 g pure | >10¹² | ◯ |
| BHET + BHEET + DEG + PA | water | | |
| BHET:BHEET = 11:1 | 0.2 g CNT | >10¹² | ◯ |
| | suspension | | |
| | 0.4 g CNT | >10¹² | ◯ |
| | suspension | | |
| | 0.6 g CNT | >10¹² | ◯ |
| | suspension | | |
| | 0.8 g CNT | 10¹¹ | ◯ |
| | suspension | | |
| Example 11 | 0.2 g pure | >10¹² | ◯ |
| BHET + BHEET + DEG + PA | water | | |
| BHET:BHEET = 10:1 | 0.2 g CNT | >10¹² | ◯ |
| | suspension | | |
| | 0.4 g CNT | >10¹² | ◯ |
| | suspension | | |
| | 0.6 g CNT | 10¹¹ | ◯ |
| | suspension | | |
| | 0.8 g CNT | 10¹⁰ | ◯ |
| | suspension | | |
| Example 12 | 0.2 g pure | >10¹² | ◯ |
| BHET + BHEET + DEG + PA | water | | |
| BHET:BHEET = 8:1 | 0.2 g CNT | >10¹² | ◯ |
| | suspension | | |
| | 0.4 g CNT | 10¹¹ | ◯ |
| | suspension | | |
| | 0.6 g CNT | 10¹⁰ | ◯ |
| | suspension | | |
| | 0.8 g CNT | 10⁹ | ◯ |
| | suspension | | |
| Example 13 | 0.2 g pure | >10¹² | ◯ |
| BHET + BHEET + DEG + PA | water | | |
| BHET:BHEET = 7:1 | 0.2 g CNT | >10¹² | ◯ |
| | suspension | | |
| | 0.4 g CNT | >10¹² | ◯ |
| | suspension | | |
| | 0.6 g CNT | 10¹¹ | ◯ |
| | suspension | | |
| | 0.8 g CNT | 10¹⁰ | ◯ |
| | suspension | | |
| Example 14 | 0.2 g pure | >10¹² | ◯ |
| BHET + BHEET + DEG + PA | water | | |
| BHET:BHEET = 6:1 | 0.2 g CNT | >10¹² | ◯ |
| | suspension | | |
| | 0.4 g CNT | >10¹² | ◯ |
| | suspension | | |
| | 0.6 g CNT | >10¹² | ◯ |
| | suspension | | |
| | 0.8 g CNT | 10¹¹ | ◯ |
| | suspension | | |

As shown in Table 3, the polyurethane foams produced using the polyester polyols of Examples 10 to 14 do not have melt drop production, i.e., having superior flame retardancy. It is demonstrated that the polyester polyols of Examples 10 to 14 produced using the diol monomeric component of Formula (I) has superior flame retardancy.

In addition, the polyurethane foam produced using each of the polyester polyols of Examples 11 to 13 has a surface resistance which is significantly reduced when the amount of the aqueous carbon nanotube suspension used for the production thereof is gradually increased. Specifically, the surface resistance of the polyurethane foam produced using the polyester polyol of Example 12 is reduced most significantly when the amount of the aqueous carbon nanotube suspension used for the production thereof is gradually increased. It is demonstrated that the polyester polyols of Examples 11 to 13 further has superior dispersibility.

The property evaluation results of the polyester polyols of Examples 2 to 9 and Comparative Examples 4 and 5 and the polyurethane foams produced thereby are shown in Table 4 below. In Examples 2 to 9 and Comparative Examples 4 and 5, the weight ratio of BHET to BHEET was 9:1, the total weight of BHET and BHEET was 100 g, and the amount of PA was 85 g.

TABLE 4

| | | | | | | | | | Comparative | |
|---|---|---|---|---|---|---|---|---|---|---|
| | Examples | | | | | | | | Examples | |
| | 2 | 3 | 4 | 5 | 6 | 7 | 8 | 9 | 4 | 5 |
| C₂-C₉ | DEG | DEG | DEG | DEG | EG | EG | EG | EG | DEG | DEG |
| short-chain | 140 g | 120 g | 100 g | 80 g | 140 g | 130 g | 120 g | 110 g | 180 g | 160 g |
| diol component | | | | | | | | | | |
| a weight ratio | 1.4 | 1.2 | 1 | 0.8 | 1.4 | 1.3 | 1.2 | 1.1 | 1.8 | 1.6 |
| of C₂-C₉ | | | | | | | | | | |
| short-chain | | | | | | | | | | |
| diol component | | | | | | | | | | |
| to diol | | | | | | | | | | |
| monomeric | | | | | | | | | | |
| component of | | | | | | | | | | |
| Formula (I) | | | | | | | | | | |
| Viscosity (cP) | 10,000 | 25,000 | 38,000 | 59,000 | 8,500 | 14,500 | 21,000 | 27,000 | 4,100 | 6,500 |
| Alcohol value | 360 | 307 | 251 | 209 | 683 | 620 | 575 | 526 | 462 | 416 |
| (mg KOH/g) | | | | | | | | | | |
| Melt drop | ◯ | ◯ | ◯ | ◯ | ◯ | ◯ | ◯ | ◯ | X | X |
| Foamability | ⊚ | ⊚ | ◯ | ◯ | ⊚ | ⊚ | ⊚ | ⊚ | ⊚ | ⊚ |
| Three-point | 299 | 334 | —* | — | 118 | 126 | 134 | 146 | 216 | 251 |
| compression | | | | | | | | | | |
| value (N/cm²) | | | | | | | | | | |

Note:
*not measured

As shown in Table 4, for the polyester polyols of Examples 2 to 9, in which the weight ratio of the C₂-C₉ short-chain diol component to the diol monomeric component of Formula (I) is less than 1.6, the polyurethane foams produced using the polyester polyols of Examples 2 to 9 do not have melt drop production (i.e., having superior flame retardancy), demonstrating that the polyester polyols of Examples 2 to 9 has superior flame retardancy. Contrary thereto, for the polyester polyols of Comparative Examples 4 and 5, in which the weight ratio of the C₂-C₉ short-chain diol component to the diol monomeric component of Formula (I) is larger than 1.6, the polyurethane foams produced using the polyester polyols of Comparative Examples 4 and 5 have melt drop production, demonstrating that the polyester polyols of Comparative Examples 4 and 5 has inferior flame retardancy.

Furthermore, compared to the polyester polyols of Examples 4 and 5, the polyester polyols of Examples 2, 3, and 6 to 9 have relative low viscosity values and are more suitable for further processing, and the polyurethane foams produced thereby have relatively good foamability. In addition, as shown by the results for Examples 2 to 5, the viscosity value of the polyester polyol is reduced when the amount of DEG is increased such that the production of polyurethane foam is relatively easy and that the foamability of the polyurethane foam thus produced can be enhanced.

In view of the aforesaid, in the process for producing a polyester polyol according to the disclosure, a diol composition including a C₂-C₉ short-chain diol component and a diol monomeric component of Formula (I) in a specific weight ratio is used so as to permit the polyester polyol thus produced to have superior flame retardancy, such that a polyurethane foam having superior flame retardancy can be produced without the use of additional flame retardant. In addition, the thus produced polyester polyol has superior dispersibility such that the polyester polyol can be homogeneously mixed with polyisocyanate and various optional functional additives to produce polyurethane foam having desirable superior performances without comprising the flame retardancy.

In the description above, for the purposes of explanation, numerous specific details have been set forth in order to provide a thorough understanding of the embodiment (s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

1. A process for producing a polyester polyol, comprising the steps of:
(a) preparing a diol composition which includes a C₂-C₉ short-chain diol component and a diol monomeric component of Formula (I) in a weight ratio of the C₂-C₉ short-chain diol component to the diol monomeric component of Formula (I) of larger than 0 and less than 1.6, 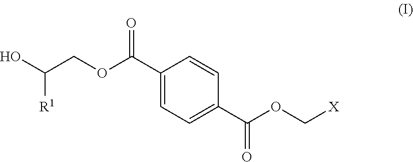
wherein
R¹ is selected from the group consisting of hydrogen, phenyl, a C₁-C₆ straight alkyl group, and a C₃-C₆ branched alkyl group, and
X is selected from the group consisting of 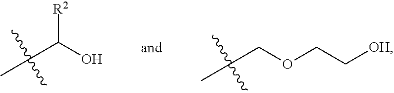
wherein R² is selected from the group consisting of hydrogen, phenyl, a C₁-C₆ straight alkyl group, and a C₃-C₆ branched alkyl group;
(b) preparing a dicarbonyl composition which includes one selected from the group consisting of a dicarboxylic acid component, a dicarboxylic anhydride component, and a combination thereof; and
(c) subjecting the diol composition and the dicarbonyl composition to a polycondensation reaction.

2. The process according to claim 1, wherein in step (a), the diol monomeric component of Formula (I) includes one selected from the group consisting of a first diol monomer of Formula (I-1), a second diol monomer of Formula (I-2), and a combination thereof, 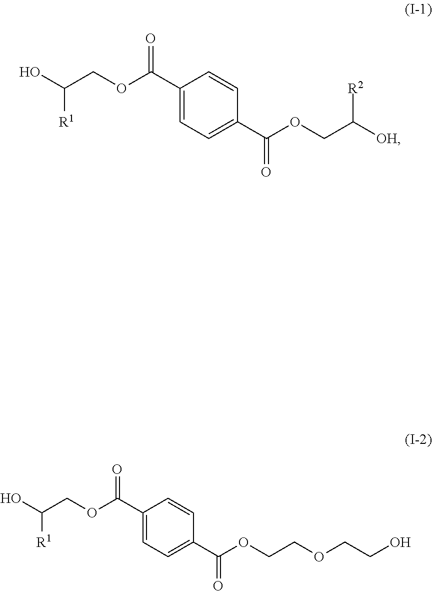
wherein each of R¹ and R² is independently selected from the group consisting of hydrogen, phenyl, a C₁-C₆ straight alkyl group, and a C₃-C₆ branched alkyl group.

3. The process according to claim 1, wherein in step (a), the C₂-C₉ short-chain diol component is selected from the group consisting of ethylene glycol, diethylene glycol, propylene glycol, butanediol, and combinations thereof.

4. The process according to claim 3, wherein in step (a), the C₂-C₉ short-chain diol component is diethylene glycol.

5. The process according to claim 2, wherein the diol monomeric component of Formula (I) includes a combination of the first diol monomer of Formula (I-1) and the second diol monomer of Formula (I-2).

6. The process according to claim 5, wherein in step (a), the first diol monomer of Formula (I-1) and the second diol monomer of Formula (I-2) are mixed with each other at a mixing temperature which is lower than a prepolymerization temperature at which the first diol monomer of Formula (I-1) and the second diol monomer of Formula (I-2) are subjected to a prepolymerization reaction.

7. The process according to claim 6, wherein the mixing temperature is in a range from 120° C. to 180° C.

8. The process according to claim 1, wherein in step (c), the polycondensation reaction is implemented at a temperature ranging from 180° C. to 300° C.

9. A polyester polyol produced by the process according to claim 1.

10. A polyurethane foam produced by subjecting the polyester polyol according to claim 9 and a polyisocyanate to a reaction.
